(19) United States
(12) Patent Application Publication
(10) Pub. No.: US 2008/0203097 A1
(43) Pub. Date: Aug. 28, 2008

(54) Universal system for underground storage and elevation of solid waste containers

(75) Inventors: Nuno Filipe Cardoso Cabral Martins da Silva, Porto (PT); Nuno Antonio da Silva Lopes, Porto (PT); Tiago Amorim da Costa Almeida, Porto (PT)

Correspondence Address: SUGHRUE MION, PLLC, 2100 PENNSYLVANIA AVENUE, N.W., SUITE 800, WASHINGTON, DC, 20037, US

(73) Assignee: TNL-SOCIEDADE DE EQUIPAMENTOS ECOLOGICOS E SISTEMAS AMBIENTAIS, LDA, Porto (PT)

(21) Appl. No.: 11/709,817

(22) Filed: Feb. 23, 2007

(51) Int. Cl. B65F 1/14

(52) U.S. Cl. 220/484

(57) ABSTRACT

The present invention applies to the collection of solid waste into underground equipment and it refers to a system by which an underground pit is used to house one or more solid waste container(s).

The system for the collection of solid waste as described by the current invention has a hydraulically activated platform on which one or more waste containers can be placed. It is made up of a bottom structure, a lid, an external surface, one or more deposit bins, two or more hydraulic cylinders, two or more structures that push and support the lid and a leveling structure. This platform, which can match the slope of the surrounding surface, is leveled and secured to a concrete pit.

### TECHNICAL AREA OF INVENTION

The present invention applies to the collection of solid waste into underground equipment.

The present invention refers to a system by which an underground pit is used to house one or more solid waste container(s).

### ANTECEDENTS TO THE INVENTION

There is prior art detailing methods for achieving universal systems for the underground storage and elevation of solid waste containers by means of an appropriately modified truck.

These containers are, frequently, placed within a concrete pit which is directly beneath a hydraulically or kinematically operated lid.

Deposit bins located at surface level and integrated into the hydraulically activated lid, allow users to load solid waste into the containers below the surface.

These containers have support attachments that allow them to be emptied by different types of collection vehicles.

During the collection process, the weight of the containers makes them subject to heavy loads during movement. In order for these movements to be as smooth as possible, the ground and the lid need to be level with the slope of the surrounding street.

This situation creates delicate conditions for the operator during loading and unloading. Any accident will necessarily require a maintenance intervention to re-establish proper system functioning.

Patents U.S. Pat. NO. 5,573,085 e EP0608767 represents two such similar systems for the collection and extraction of solid waste. The present invention has a distinct advantage over these systems in that it can be leveled to the slope of the street, to the waste deposit bins as well as to the adjustable platform. This allows for the system to be elevated or lowered by either lateral, front, back or crane operated vehicles without obstacle.

Other advantages with relation to existing systems are as follows: the platform is modular and can be lengthened or heightened to house containers of any width and height; the design and opening mechanism of the deposit bins prevents users from ever having visual contact with the waste material underground, while also minimizing potential odors; optional sensors can be mounted on the platform to facilitate the collection of the waste containers.

### BRIEF DESCRIPTION OF THE FIGURES

Figures have been provided to better describe the present invention. The figures represent the following:

FIG. 1: shows a side view of the underground equipment for waste collection in the elevated position. In this figure we can see the container (1), the bottom portion of the structure (2), the lid (3), the exterior platform (4), the deposit bin (5), the hydraulic cylinder (6), the structure that pushes the lid (7), the leveling structure (8) the concrete pit (9);

FIG. 2: shows a perspective view of the remote control (10) with control buttons (11) for activating the system;

FIG. 3: shows a detail view of the command key (12) at the orifice of the command tower (13) that interlocks the system;

FIG. 4: shows a general perspective view of the system, with the bottom portion of the platform (2) visible as well as the lid (3), the exterior surface (4), the hydraulic cylinder (6), the structure that pushes the lid (7), the leveling structure (8), the rectangular housing of the deposit bin (15), the cylindrical drum of the bin (17) the bin handle (19);

FIG. 5: shows a detail view of the struts (14) that level the lid (3) and the exterior surface (4);

FIG. 6: shows a detailed view of the leveling of the deposit bin (5) made up of a bracket (16) and adjustment struts (18);

FIG. 7: shows a perspective view of the platform in the elevated and open position, highlighting the elements of the bottom portion of the structure (2) made up of: a base (20), the adjustable platform (21), the stabilizing structure (23) and the support structure (24);

FIG. 8: shows a detailed view of the leveling mechanism of the adjustable surface (21) through the use of leveling struts (22);

FIG. 9: shows a lateral view of the collection of standard containers (25) through the use of a back-loading truck (26);

FIG. 10: shows a lateral view of the collection of standard containers (28) through the use of a side-loading truck (27);

FIG. 11: shows a lateral view of the collection of standard containers (30) through the use of a front-loading truck (29);

FIG. 12: shows a lateral view of the collection of standard containers (31) through the use of a crane-equipped truck (32).

FIG. 13: shows a scheme for the communication system via RF (34), or cellular network (35) between a control module (33), placed next to the platform, and a central dispatch (36) using a PC (37).

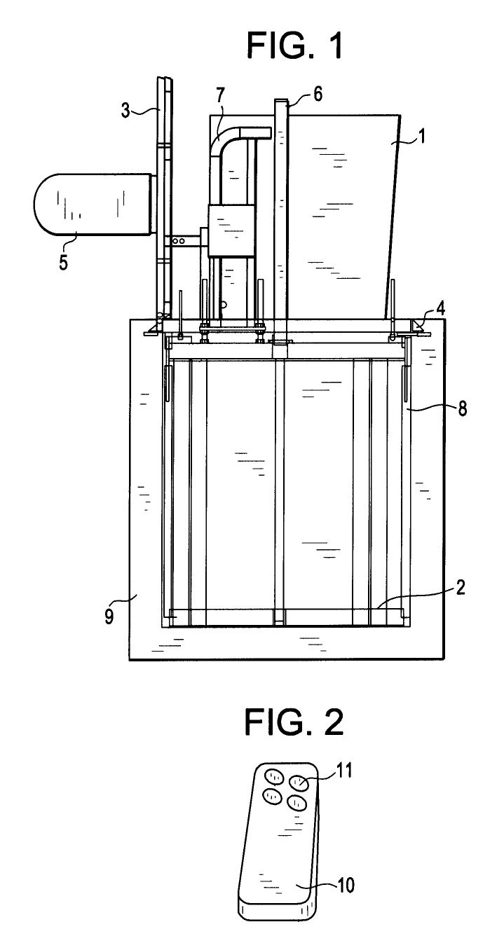

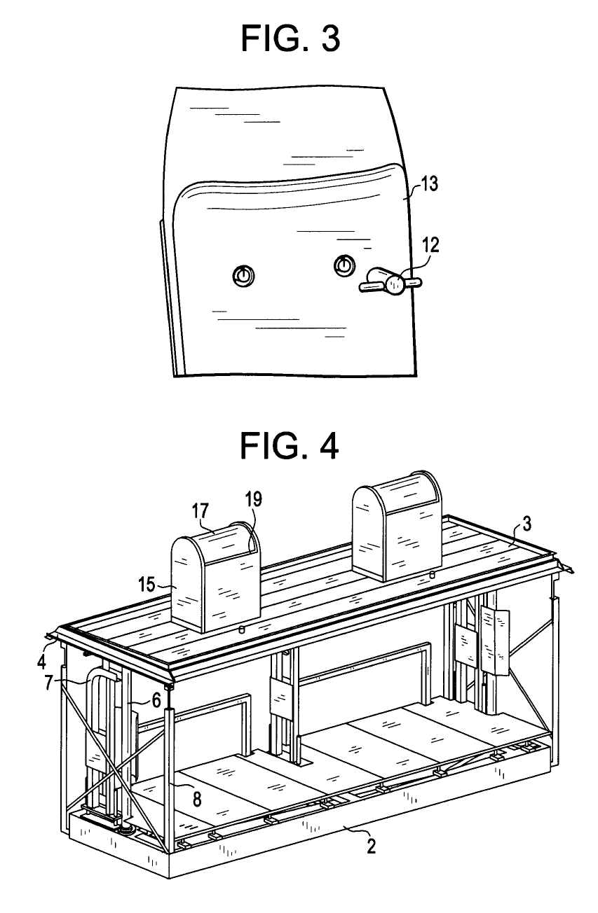

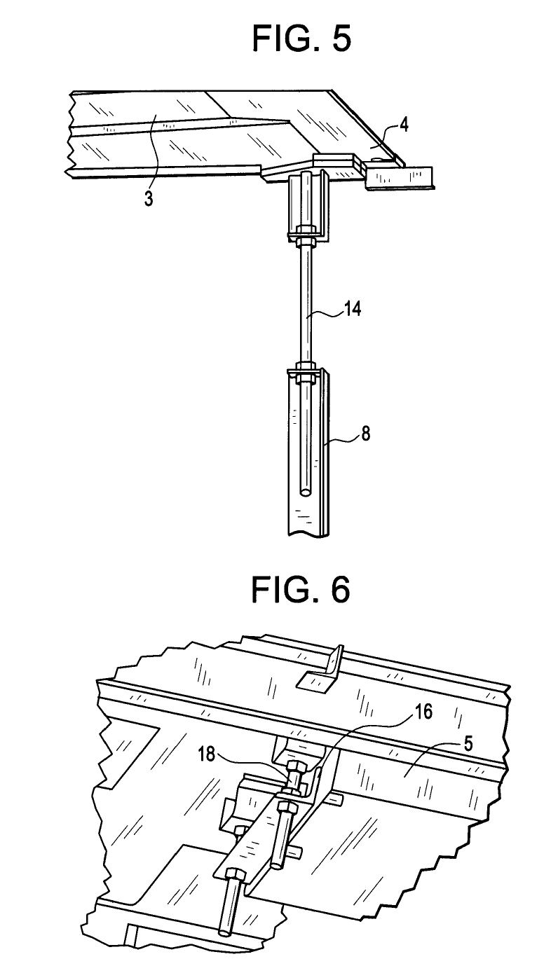

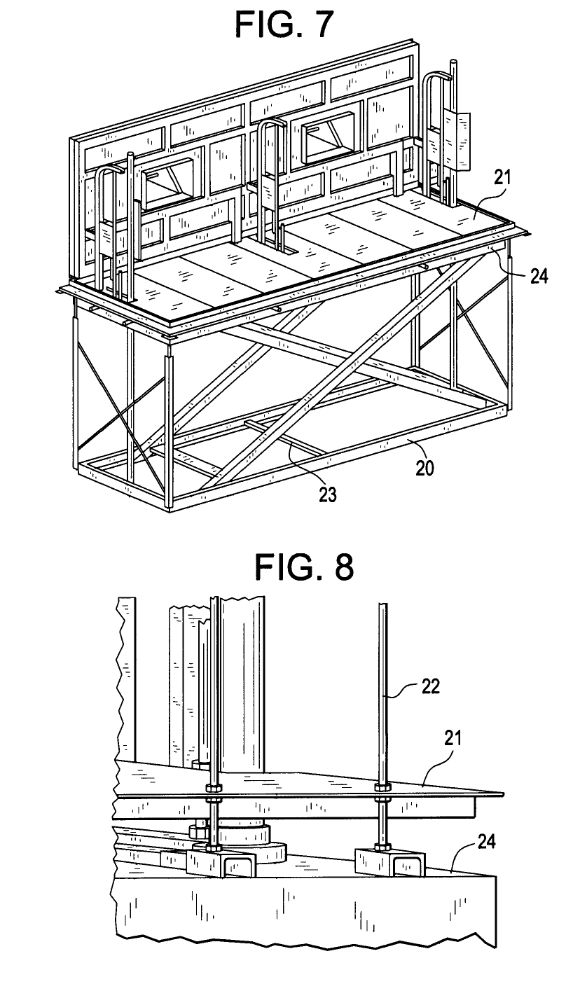

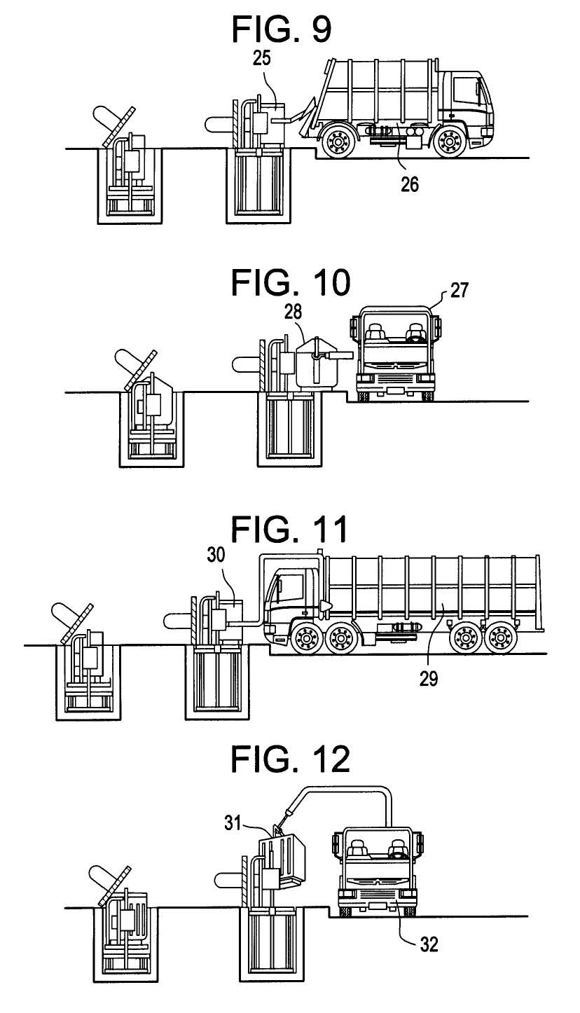

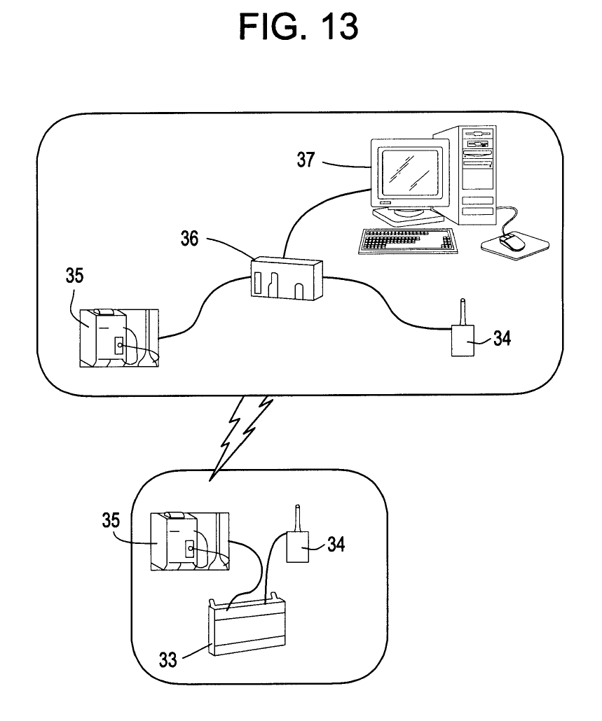

### DETAILED DESCRIPTION OF THE INVENTION

The system for the universal collection of solid waste as described by the current invention has a hydraulically activated platform on which one or more waste containers can be placed (1). It is made up of a bottom structure (2), a lid (3), an external surface (4), one or more deposit bins (5), two or more hydraulic cylinders (6), two or more structures that push (7) and support the lid (3) and a leveling structure (8). This platform, which can match the slope of the surrounding surface, is leveled and secured to a concrete pit (9).

The collection process begins with the platform opening through the injection of oil into the hydraulic circuit. The oil is injected from either a stand-alone autonomous supply or from a hydraulic injection line directly from the collection truck (26, 27, 29, 32).

Electrical power to the control module can be supplied through the local power grid or through a photovoltaic solar cell which accumulates solar energy in a local battery store. The solar panel and its supports reside on the exterior of the system next to the platform.

The stand-alone hydraulic source can be activated through a remote control (10) with two or more buttons (11) or through a control key (12) inserted into an opening in the control tower (13) on the exterior of the equipment. Releasing button on the remote control (11) or the control key (12) will stop the movement of the system. The hydraulic system is equipped with safety valves that will block in case of a possible uncontrolled drop of the platform. In the case of an existing hydraulic line on the collection truck is usually activated by a lever that sends the oil to the platform through a feeder hose that is connected to the equipment through a hydraulic quick coupling.

The control module is located in a second pit right next to the concrete pit (9) where the platform and containers are buried. This second pit is covered with a lid that is leveled and surfaced in accordance with the surrounding street (cobblestone, paving, asphalt etc.). The control tower (13) is mounted directly on the lid.

By activating the hydraulic cylinder (6), the bottom structure (2) ascends, pushes the lid (3) open to 90 degrees and the containers (1) are elevated to street level. Once the containers (1) have been emptied, the closing of the lid (3) and the lowering of the bottom structure (2) is accomplished by allowing gravity to act on the platform which empties the hydraulic cylinders (6).

The lid (3) is pushed by two or more structures (7) which contain wheels riding on a track which starts horizontally, curves and then drops vertically. The lid (3) opens to a position with an angle of 90 degrees through wheels in its underside which ride over the curved portion of the rail. The lid (3) rotates about several hinges in the external surface (4) which envelopes the lid and which needs to be built on site during construction.

The lid (3) and the external surface (4) are leveled to the surrounding slope through four threaded struts (14) placed on each of the four corners. These struts are attached to the leveling structure (8) which in turn is attached to the bottom structure (2).

The lid (3) is located at the surface, in the public area and can support any type of finished surface paving (cement, granite, cobblestone, etc.). The lid is lined with thick rubber to seal in odors and keep out water.

The deposit bins (5) are found at the surface, flush and level with the lid. The deposit bin (5) is composed of a rectangular body (15), two brackets (16) and a circular drum (17). The deposit bin (5) is leveled through the use of four threaded struts (18) attached to the two brackets (16) and to the lid (3).

The circular drum (17), which has a handle (19), rotates within the rectangular body (15), and serves as the opening, which, when the platform is closed and in operation, allows users to place waste into the system which will descend by gravity into the containers below the surface (1). The user places the waste inside the circular drum without any visual contact of the previously deposited residues within the container below.

The deposit bin (5) has an optional back door for accommodating larger waste.

The circular drum can be locked through an electronic or mechanical lock situated on the back of the bin. Only authorized users, in possession of appropriate keys or magnetic cards will be able to activate the button that unlocks the drum to deposit waste.

In the case of a magnetic card system, an audit access records can be stored. The time and date of each operation can be recorded either locally or sent via RF to a central dispatch.

The bottom structure (2) is composed of a base (20), an adjustable platform (21) a stabilizing structure (23) and a support structure (24).

The adjustable platform (21) is also leveled to match the slope of the surrounding street through the use of various threaded struts (22) attached to the adjustable platform (21) and to the support structure (24). One or more waste containers (1) are placed under the adjustable platform (21). Once the adjustable platform (21) is perfectly leveled, it serves as a safety platform for people walking by during waste collection and preventing anyone from falling into an open pit.

The stabilizing structure (23) consists of a scissor lift or similar structure that moves through rotating elements connected to the base (20) as well as the support structure (24). The base (20) is supported and fixed to the bottom of the concrete pit (9).

The base is designed to support the loads and weights of full 500 to 6000 liter waste containers. The platform is modular in order to accommodate longer or taller standard containers.

The platform is designed specifically to enable and not impede the collection of waste from either side, front, rear or crane loading trucks.

Once the containers are elevated to street-level, the rear-loading collection can proceed by backing the truck into position and lifting the standard container (25) into the truck opening (26) thus emptying the waste container.

Lateral or front collection is activated by an operator within the collection truck (27 or 29). Once the truck (27 or 29) is aligned with the equipment, the collection of waste occurs in the standard fashion: using the front or side elevator arm to (27 or 29) to grip the standard container (28 or 30) end emptying the waste.

Crane lifted collection is also possible through the normal procedure: Once the platform is opened, the operator lifts the container (31) using the crane attached to the truck (32). A hook and loop mechanism typically enables the crane to lift the container into place above the truck (31) where the base of the container is opened to dump its contents into the truck (32).

For security purposes, the platform can produce a warning light and siren when the lid is being opened. The system is comprised of two sensors, equipped with lights and sirens, mounted on the lid.

Weight and level sensors can be placed on the lid and on the adjustable platform which relay information regarding the weight in the container and the level of waste inside them to the control module outside the platform. This allows for pickup to be scheduled as required.

Aside from processing weight and level information, the control module (33) can also provide additional information related to waste pickup for subsequent statistical analysis such as; date/time of pickup as well as total duration of each operation and dispatch.

The control module (33) processes, stores and sends required information via RF (34) or cellular network (35). With the adoption of GSM (35) or RF (34) modules in each container, a central dispatch can communicate with each individual container and download real time data regarding its status (weight, fill level etc).

With this system it is also possible to send alarms from each container to a central dispatch station (35) or to other users. Messages are automatically sent via the cellular network module (35) or the RF module (34) once pre-defined levels are achieved (e.g.: electrical power supply alarm; current waste level alarm; etc.). These messages can be sent to a central monitoring station or to a list of pre-defined users. At the monitoring station, data is received and processed on a computer. Having real time information such as waste levels in each container allows operators at the dispatch station to better plan pickup routes each day.

The description contained herein of the universal system for underground storage and elevation of solid waste containers is a non-limiting example which is subject to modifications and variations by subject matter experts under licensed use of this invention.

What is claimed is:

1. A universal system for underground storage and elevation of solid waste containers comprising a hydraulically activated platform within a concrete pit, onto which one or more containers are placed, wherein it comprises:
one or more waste containers; an inferior structure; a lid; an exterior surface; One or more waste deposit bins; two or more hydraulic cylinders; two or more structures that push and support the lid; a leveling structure made up of struts attached to the external surface and the bottom structure which is leveled and attached to the concrete pit;
two or more hydraulic cylinders to raise and lower the bottom structure, which is leveled in accordance with the surrounding street slope at surface level through the use of various struts attached to the adjustable surface and the support structure;
the lid opening with na angle of 90 degrees with the surface as defined by the external surface; and rotating about several hinges in the external surface which envelopes the lid and which needs to be built on site during construction, with the surface and the lid leveled according to the surrounding street level slope through the use of four adjustable struts located on each of the four corners and attached to the leveling structure which in turn is attached to the bottom structure.

2. The universal system, according to claim 1, wherein it comprises:
a lid containing one or more waste deposit bins which have a rectangular body, two brackets and a cylindrical drum;
each bin leveled through the use of four adjustable struts attached to the brackets as well as to the lid; and
a cylindrical drum with a handle which rotates on the rectangular body serving as the access mouth which, when the platform is closed and in operation, allows users to drop waste into the container below.

3. The universal system, according to claim 2, wherein the waste deposit bin has a rear access door for larger waste material.

4. The universal system, according to claim 2, wherein it comprises:
a cylindrical drum closing through the use of an electronic or mechanical key on the back of the bin;
a drum opening only to users with the key or magnetic card to unlock the system.

5. The universal system, according to claim 4, wherein the date and time information is registered each time the drum is opened by magnetic card access.

6. The universal system, according to claim 1, wherein it comprises:
a bottom structure composed by a base, an adjustable platform a stabilizing structure and support structure;
an adjustable platform leveled to match the slope of the surrounding street level through the use of various threaded struts which are attached to the adjustable platform and to the support structure;
a stabilizing structure consisting of a scissor lift or similar structure that through rotating elements connected to the base as well as the support structure.

7. The universal system, according to claim 1, wherein it comprises sensors in the lid triggering alert sirens and lights when the lid is being opened.

8. The universal system, according to claim 1, wherein:
the lid and the adjustable platform having weight and level sensors which relay information regarding the weight and level of the waste inside the containers to a control module on the exterior of the platform, where the information is used for management of the waste pickups;
a the control module that provides information relating to the pickup process by each truck and making the data available for statistical post-processing as well as sending said information via RF or cellular network to a central dispatch station which has real-time access to this data for each container.

9. The universal system, according to claim 1, wherein it comprises:
a modular construction method, allowing its length and height to be altered in order to house any type of standard container;
a lid, which rotates about several hinges in the surface in order to facilitate the four types of pick up methods: rear-loading, lateral-loading, front-loading, or by crane.
